(19) United States
(12) Patent Application Publication
(10) Pub. No.: US 2007/0094218 A1
(43) Pub. Date: Apr. 26, 2007

(54) Apparatus and method for using fuzzy case-based reasoning to generate a sales order

(75) Inventor: Cheranellore Vasudevan, Austin, TX (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, Armonk, NY (US)

(21) Appl. No.: 11/201,974

(22) Filed: Aug. 11, 2005

(51) Int. Cl. G06N 7/02; G06F 9/44

(52) U.S. Cl. 706/52

(57) ABSTRACT

A fuzzy case-based order generation mechanism stores each order in a repository, and generates fuzzy indexes for each stored order. When a new order needs to be generated, the user may specify a partial order definition, and the repository may be searched using the fuzzy indexes to determine if any of the stored orders match the partial order definition. If so, one or more stored orders may be presented to the user. The user may select one of the stored orders, then modify the stored order to define a new sales order. In this manner, previous sales orders may be quickly and efficiently used to generate a new sales order using fuzzy case-based reasoning.

### BACKGROUND OF THE INVENTION

1. Technical Field

This invention generally relates to computer database systems, and more specifically relates to mechanisms and methods for generating sales orders.

2. Background Art

Moden systems for generating sales orders for complex products like computer systems require specifying many different features. If a user has to specify each feature for each computer system that is ordered, the order entry process becomes very time-consuming and inefficient. One way to potentially shorten the time required to order a computer system is to use a previously-ordered computer system as a starting point, then modify the order to reflect the configuration of the desired computer system. A problem with this approach is there is no good way to catalog existing orders. As a result, the user must remember which orders have which features. As the number of orders grows, remembering the features of many different orders becomes increasingly difficult. Without a way to improve the efficiency of order entry for complex products, the current methods will result in undue cost and inefficiency in generating sales orders.

### DISCLOSURE OF INVENTION

According to the preferred embodiments, a fuzzy case-based order generation mechanism stores each order in a repository, and generates fuzzy indexes for each stored order. When a new order needs to be generated, the user may specify a partial order definition, and the repository may be searched using the fuzzy indexes to determine if any of the stored orders match the partial order definition. If so, one or more stored orders may be presented to the user. The user may select one of the stored orders, then modify the stored order to define a new sales order. In this manner, previous sales orders may be quickly and efficiently used to generate a new sales order using fuzzy case-based reasoning.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is block diagram showing details of the configuration repository shown in FIG. 1;

FIG. 3 is a flow diagram of a method for storing a sales order with associated fuzzy indexes in accordance with the preferred embodiments;

FIG. 4 is a flow diagram of a method for retrieving and using a stored sales order to generate therefrom a new sales order;

FIG. 5 is a block diagram of a first sample sales order for the purpose of illustrating some of the concepts of the preferred embodiments;

FIG. 6 is a block diagram of sample fuzzy indexes for the sales order shown in FIG. 5;

FIG. 7 is a block diagram of a second sample sales order for the purpose of illustrating some of the concepts of the preferred embodiments;

FIG. 8 is a block diagram of sample fuzzy indexes for the sales order shown in FIG. 7; and

FIGS. 9-14 each show index definitions for a different fuzzy index in accordance with the preferred embodiments.

### BEST MODE FOR CARRYING OUT THE INVENTION

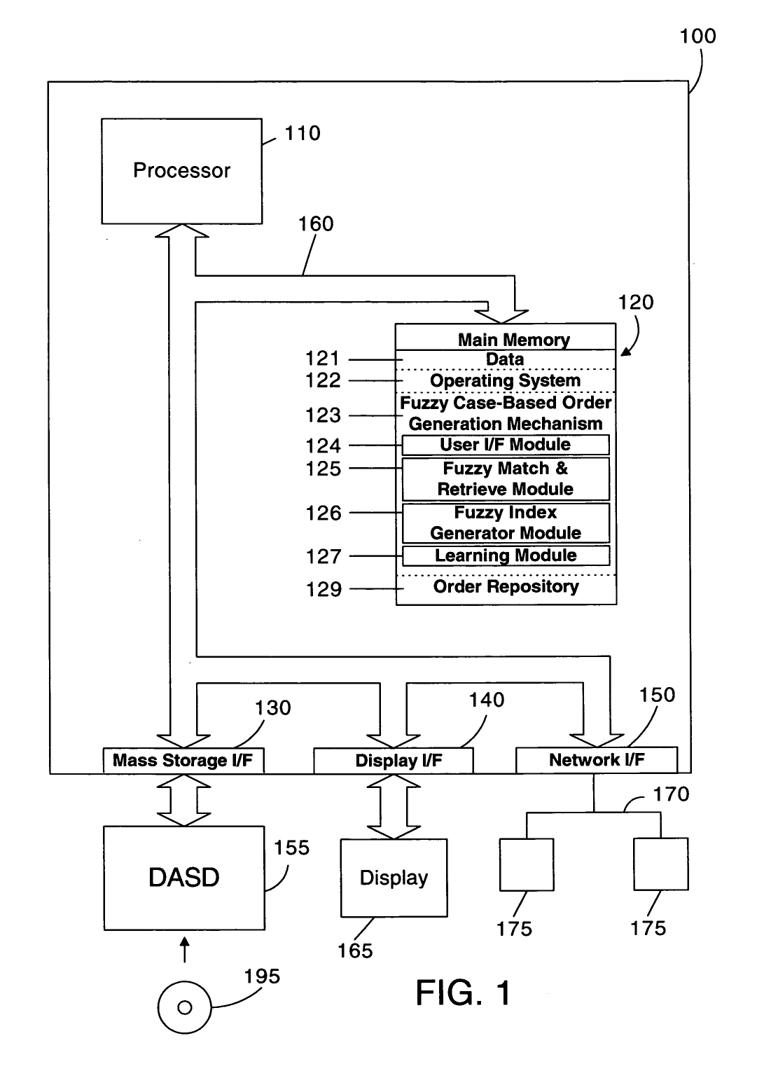

The preferred embodiments provide an enhanced system and method for generating sales orders by storing previous orders in a repository and generating fuzzy indexes for the stored orders that allow determining whether a stored order may be efficiently used to generate a new order. A user specifies a partial order definition, which is used to interrogate the stored orders in the repository using the corresponding fuzzy indexes to determine whether there is a full or partial match for the partial order definition. If a match is found, the matching stored order is retrieved and presented to the user. The user may then make appropriate changes to the stored order to generate a new order. By using an existing sales order as a starting point for generating a new order, the efficiency of the order entry process is increased. Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

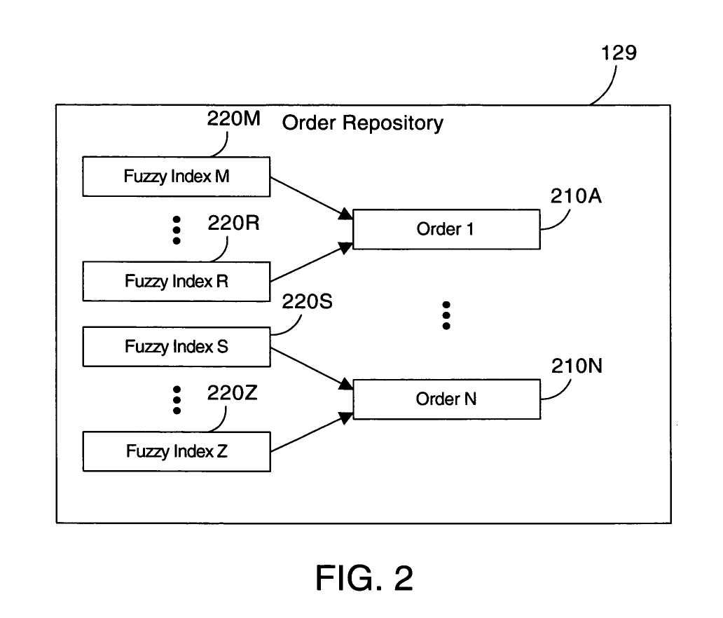

Main memory 120 in accordance with the preferred embodiments contains data 121, an operating system 122, a fuzzy case-based order generation mechanism 123, and an order repository 129. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. The order repository 129 includes multiple orders, as will be discussed below in more detail with reference to FIG. 2.

The fuzzy case-based order generation mechanism 123 includes a user interface module 124, a fuzzy match and retrieve module 125, a fuzzy index generator module 126, and a learning module 127. The user interface module 124 provides a graphical user interface that may be used by a user to enter an order, to enter a partial order, to edit an existing order, and to store an order in the order repository 129. The fuzzy match and retrieve module 125 receives a partial order definition from the user interface module 124, then sees if any of the stored orders in the order repository 129 provide a full or partial match to the partial order definition. In the most preferred implementation, the partial order definition is a set of fuzzy index values generated by the fuzzy index generator module 126 from the user's input regarding desired characteristics for the new order. Note that a partial order definition may be any order definition that is lacking some information. Note also that what constitutes a “partial match” may be determined with any suitable heuristic within the scope of the preferred embodiments, whether simple or complex. For example, a very simple heuristic would produce a partial match if more than 50% of the information in the partial order definition is also in a stored order. The fuzzy match and retrieve mechanism 125 preferably uses known fuzzy aggregation techniques to determine whether any stored orders provide a partial match to the partial order definition. If a full or partial match is found, the fuzzy match and retrieve mechanism 125 returns the stored order that matched to the user interface module 124. A user may then modify the stored order to generate therefrom a new order. Note that there may be multiple stored orders that partially match. In this situation, the fuzzy match and retrieve mechanism 125 returns a list of the stored orders that partially match, allowing the user to select one from the list. The selected order is then returned to the user interface module 124, where the user may modify the selected order to generate therefrom a new order.

The fuzzy index generator module 126 creates multiple fuzzy indexes for each order stored in the order repository 129, and creates one or more fuzzy indexes that correspond to a partial order definition entered by a user. In the preferred embodiments, the fuzzy indexes corresponding to a stored order are also stored in the order repository 129. By generating fuzzy indexes, the fuzzy match and retrieve module 125 may use the fuzzy indexes to see if any of the stored orders in the order repository 129 partially match a partial order definition. The learning module 127 identifies when a generated order is unique so the order may be stored in the order repository 129. In addition, the learning module 127 may also receive user input via the user interface module 124 that rates the retrieved solution so the learning mechanism 127 may dynamically update the fuzzy indexes or their values so the matching process may be improved in an ongoing manner.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, fuzzy case-based order generation mechanism 123, and order repository 129 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links (e.g., software downloaded over the internet). Note that the preferred signal bearing media is tangible.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

In one implementation in accordance with the preferred embodiments, details of the order repository 129 are shown in FIG. 2. The order repository 129 includes a plurality of orders 210, shown in FIG. 2 as 210A, . . . , 210N. Each order has a plurality of corresponding fuzzy indexes. Thus, order 210A in FIG. 2 is shown to include multiple fuzzy indexes 220, represented in FIG. 2 as 220M, . . . , 220R. In similar fashion, order 210N in FIG. 2 is shown to include multiple fuzzy indexes 220, represented in FIG. 2 as 220S, . . . , 220Z. Each fuzzy index contains information that corresponds to the order, and is used to determine whether an existing order matches a partial order definition so the existing order may be used as a starting point for entering a new order. While the concept of providing a fuzzy index for a database table is known in the art, the preferred embodiments provide multiple fuzzy indexes for each stored order, and the fuzzy indexes can be different for each stored order as applicable. In this manner, the stored orders may be easily searched without the overhead of providing fuzzy indexes that include data from all of the orders.

Note that the fuzzy indexes in FIG. 2 are shown to reside within the order repository 129. However, the fuzzy indexes could also be stored in a different location within the scope of the preferred embodiments, so long as the correlation between a fuzzy index and its corresponding stored order is maintained.

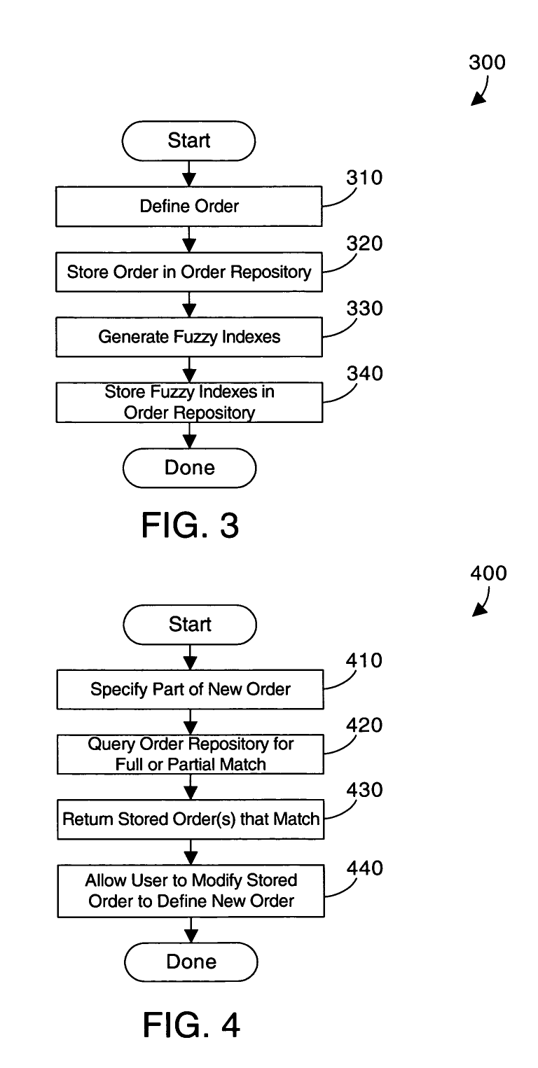

Referring now to FIG. 3, a method 300 in accordance with the preferred embodiments begins by defining an order (step 310). The order is then stored in the order repository (step 320). Fuzzy indexes are generated for the stored order (step 330). Note that the generation of fuzzy indexes in step 330 is preferably performed by the fuzzy index generator module 126 in FIG. 1. The use of fuzzy logic allows using imprecise or approximate matching of order features that may often be characterized in terms of linguistic variables. Thus, of a person wants a high speed processor, this may actually be mapped to a range of processor speeds, rather than trying to characterize each processor speed in linguistic terms. The fuzzy indexes are created based on a set of index definitions that map the linguistic descriptions to ranges of values. Once the fuzzy indexes for the order have been generated, they may be stored in the order repository (step 340). Note that step 340 may be optional if the fuzzy indexes are stored in a location different than the order repository.

Referring to FIG. 4, a method 400 in accordance with the preferred embodiments shows how order entry may be facilitated by using a stored order. First, a user uses the user interface to specify a new partial order (step 410). This new partial order defines a partial order definition that is used to see if a stored order partially matches. The order repository is queried to determine if a full or partial match exists for the partial order definition (step 420). The query of the order repository is done by comparing the partial order definition with information stored in the fuzzy indexes corresponding to each stored order. Assuming one or more stored orders match the partial order definition, the stored matching order(s) are returned (step 430). If there are multiple stored orders returned, the user may then select which stored order to use. The stored order is then used as a starting point, and the user then modifies the stored order to define a new order (step 440). Method 400 could optionally include an additional step of store the new order in the order repository. In the preferred embodiments, the learning module 127 in FIG. 1 determines whether the new order is unique, and if so, whether the new order should be stored in the order repository. This may depend, for example, on whether the new order is very similar to a stored order, which may result in the new order not being stored, or whether the new order is quite different from other stored orders, which may result in the new order being stored in the order repository.

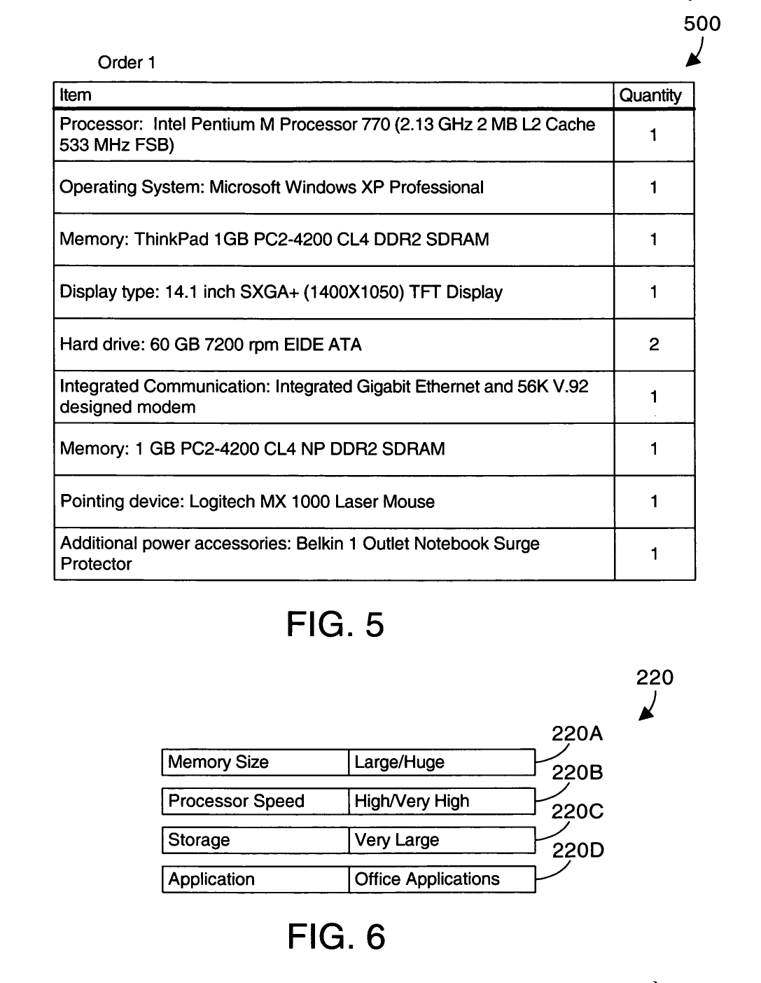

Examples are now provided to illustrate the concepts of the preferred embodiments. Referring to FIG. 5, a first sample order 500 specifies processor type, operating system, memory, display type, hard drive, integrated communications, extra memory, pointing device, and additional power accessories. We assume this order is created by a user using the user interface to explicitly add these items to the order. The first order 500 may then be stored in the order repository. FIG. 6 shows appropriate fuzzy indexes 220 that may be generated for the order 500 in FIG. 5 by the fuzzy index generator module 126 in FIG. 1. Note that these indexes are created according to the index definitions shown in FIGS. 9-14. Thus, for the first order 500, a fuzzy index 220A for memory size is created, and the memory size is Large/Huge, meaning that the memory size falls within the defined ranges for both of these linguistic descriptors. A fuzzy index for processor speed 220B is also created, and the processor speed is High/Very High, which again means that the processor speed falls within the defined ranges for both of these linguistic descriptors. A fuzzy index for storage 220C is also created, and the storage is Very Large. A fuzzy index for application 220D is also created, and the application is Office Applications. Once created, the fuzzy indexes 220 in FIG. 6 may be used to determine whether the stored order 500 partially matches a partial order definition generated from user input.

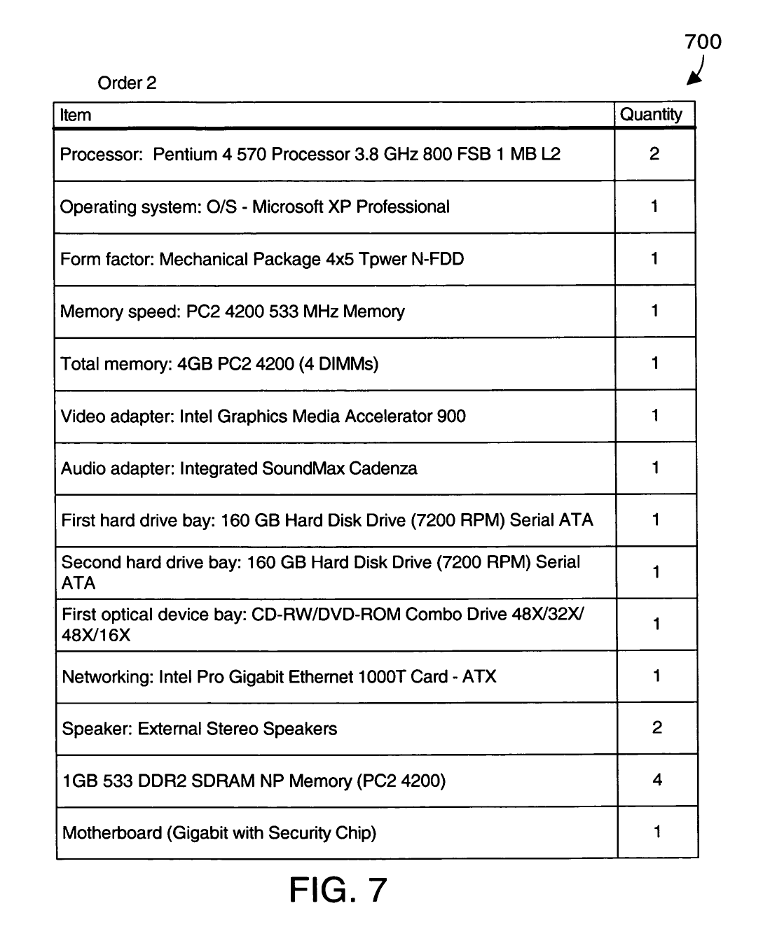

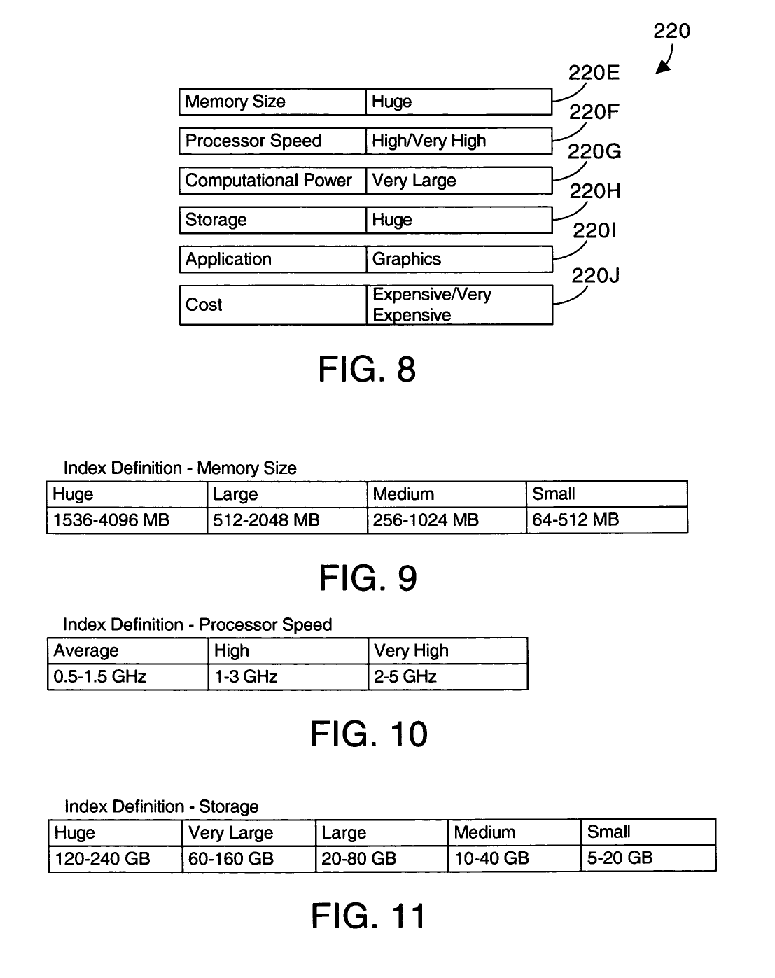

A second sample order 700 is shown in FIG. 7, and specifies processor, operating system, memory speed, total memory, video adapter, audio adapter, first hard drive bay, second hard drive bay, first optical device bay, networking, speaker, additional memory, and motherboard. FIG. 8 shows appropriate fuzzy indexes 220 that may be generated for the order 700 in FIG. 7 by the fuzzy index generator module 126 in FIG. 1. Note that these indexes are created according to the index definitions shown in FIGS. 9-14. Thus, for the second order 700, a fuzzy index 220E for memory size is created, and the memory size is Huge. A fuzzy index for processor speed 220F is also created, and the processor speed is High/Very High, which again means that the processor speed falls within the defined ranges for both of these linguistic descriptors. A fuzzy index for computational power 220G is also created, and the computation power is Very Large. A fuzzy index for storage 220H is also created, and the storage is Huge. A fuzzy index for application 2201 is also created, and the application is Graphics. A fuzzy index for cost 220J is also created, and the cost is Expensive/Very Expensive, which again means that the cost falls within the defined ranges for both of these linguistic descriptors. Once created, the fuzzy indexes 220 in FIG. 8 may be used to determine whether the stored order 700 partially matches a partial order definition entered by the user.

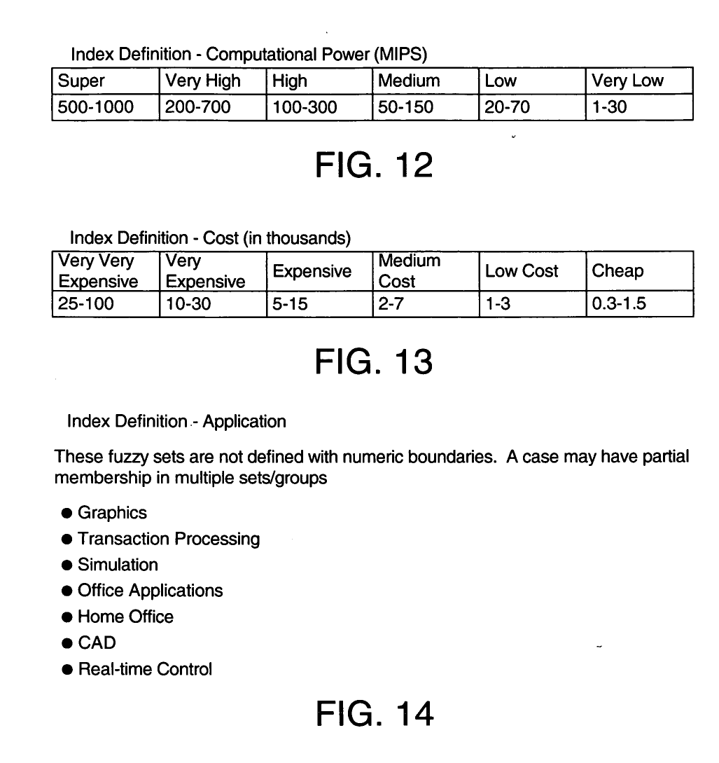

The index definitions in FIGS. 9-14 show index definitions that allow specifying these parameters in linguistic terms that may overlap. Referring to FIG. 9, we see that a memory size of Huge is defined to be 1536-4096 MB; a memory size of Large is defined as 512-2048 MB. A memory size of Medium is defined as 256-1024 MB. A memory size of Small is defined as 64-512 MB. Note that each of these ranges overlap one or more other ranges. Thus, if the memory size for a computer system is 512 MB, the fuzzy index for memory size will indicate a value of Medium/Large, because both of these linguistic descriptors describe a system with 512 MB of memory. Similarly, an index definition for processor speed is shown in FIG. 10; the index definition for storage is shown in FIG. 11; an index definition for Computational Power is shown in FIG. 12; an index definition for Cost is shown in FIG. 13; and an index definition for Application is shown in FIG. 14. Note that the index definition for Application in FIG. 14 is not described with numeric boundaries, but is descriptive of the order depending upon the features and combination of features in the order. We assume for this example that a user explicitly specifies the application at the time an order is created. Of course, it would also be possible to determine the application using a suitable heuristic based on items included in the order.

The present invention uses case-based reasoning to store an order (a case) and determine if the order may be used to generate a new order base on the stored case. The case-based approach works well because the process of ordering is episodic in nature, making orders well-suited to representation as different cases. The addition of fuzzy indexes allows using imprecise linguistic descriptors during partial order definition that allow matching the partial order definition to one or more stored cases. Of course, if no stored order partially matches the partial order definition, the new order may be generated from scratch by the user using the user interface to specify each item or combination of items in the order.

The preferred embodiments provide a way to enhance the efficiency of ordering by partially defining an order, and searching an order repository using fuzzy indexes and case-based reasoning to determine whether a stored order partially matches the partial order definition. If a stored order partially matches the partial order definition, the stored order may be retrieved and used as a starting point to define a new order, with the user changing or adding features as needed. In this manner, the work of generating an order can be substantially reduced by using previously-generated cases as a starting point for creating a new order.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor; and
a fuzzy case-based order generation mechanism that stores an existing sales order in an order repository and generates for the existing sales order a plurality of fuzzy indexes corresponding to the existing sales order, wherein the plurality of fuzzy indexes corresponding to the existing sales order are stored in the order repository, wherein the fuzzy case-based order generation mechanism comprises:
a user interface that allows a user to provide user input to define a partial order; and
a fuzzy match and retrieve mechanism that determines from the partial order definition generated from the user input whether any sales orders stored in the order repository partially match the partial order definition;
the fuzzy case-based order generation mechanism using an existing sales order in the order repository that partially matches the partial order definition to generate therefrom a new sales order.

2-4. (canceled)

5. The apparatus of claim 1 wherein if at least one sales order in the order repository partially matches the partial order definition, returning to the user a list of the at least one sales order.

6. The apparatus of claim 1 wherein the fuzzy case-based order generation mechanism comprises a learning mechanism that identifies when a generated order is unique.

7. A computer-implemented method for using fuzzy logic to generate a new sales order from an existing sales order, the method comprising the steps of:
storing the existing sales order in an order repository;
generating for the existing sales order a plurality of fuzzy indexes corresponding to the existing sales order;
storing the plurality of fuzzy indexes corresponding to the existing sales order in the order repository;
providing a user interface that allows a user to provide user input to define a partial order;
determining from the partial order definition generated from the user input whether any existing sales orders stored in the order repository partially match the partial order definition; and
using an existing sales order in the order repository that partially matches the partial order definition to generate therefrom the new sales order.

8-10. (canceled)

11. The method of claim 7 further comprising the step of, if at least one sales order in the order repository partially matches the partial order definition, returning to the user a list of the at least one sales order.

12. The method of claim 7 further comprising the step of identifying when a generated order is unique.

13. A computer-readable program product comprising:
(A) a fuzzy case-based order generation mechanism that stores an existing sales order in an order repository and generates for the existing sales order a plurality of fuzzy indexes corresponding to the existing sales order, wherein the plurality of fuzzy indexes corresponding to the existing sales order are stored in the order repository, wherein the fuzzy case-based order generation mechanism comprises a user interface that allows a user to provide user input to define a partial order, wherein the fuzzy case-based order generation mechanism comprises a fuzzy match and retrieve mechanism that determines from the partial order definition generated from the user input whether any sales orders stored in the order repository partially match the partial order definition, the fuzzy case-based order generation mechanism using an existing sales order in the order repository that partially matches the partial order definition to generate therefrom a new sales order; and
(B) computer-readable recordable media bearing the fuzzy case-based order generation mechanism.

14-18. (canceled)

19. The program product of claim 13 wherein if at least one sales order in the order repository partially matches the partial order definition, returning to the user a list of the at least one sales order.

20. The program product of claim 13 wherein the fuzzy case-based order generation mechanism comprises a learning mechanism that identifies when a generated order is unique.
